(19) United States
(12) Patent Application Publication
(10) Pub. No.: US 2017/0030630 A1
(43) Pub. Date: Feb. 2, 2017

(54) TEMPERATURE REGULATING METHOD AND TEMPERATURE REGULATING DEVICE

(71) Applicant: Xiaomi Inc., Beijing (CN)

(72) Inventors: Ke WU, Beijing (CN); Xinyu LIU, Beijing (CN)

(73) Assignee: Xiaomi Inc., Beijing (CN)

(21) Appl. No.: 15/171,345

(22) Filed: Jun. 2, 2016

(30) Foreign Application Priority Data
Jul. 31, 2015 (CN) 201510464741.X

(51) Int. Cl. F25D 29/00; G05D 23/19; G05B 15/02

(52) U.S. Cl. CPC F25D 29/00; G05B 15/02; G05D 23/1917; F25D 2600/06; F25D 2700/04; F25D 2700/06; F25D 2600/02; F25D 2600/04

(57) ABSTRACT

The present disclosure relates to a temperature regulating method and a temperature regulating device. The method includes: determining a target user who intends to use the refrigerator; acquiring target preference information of the target user on food, wherein the target preference information contains at least a target food type, a target dining time and a target food state; determining target food from food currently stored in the refrigerator based on the target food type; and regulating a temperature of a region where the target food is stored, such that the target food reaches the target food state by the target dining time.

### CROSS-REFERENCE TO RELATED APPLICATIONS

The present application is based upon and claims priority to Chinese Patent Application No. 201510464741.X filed Jul. 31, 2015, the entire contents of which are incorporated herein by reference.

### TECHNICAL FIELD

The present disclosure generally relates to the field of control technology, and more particularly, to a temperature regulating method and a temperature regulating device,

### BACKGROUND

With development of technology and improvement of people's life quality, refrigerators as one kind of household appliance have been widely used in families. The regulation of temperature in a refrigerator has a certain degree of intelligence. For example, the user can set a temperature for a region inside the refrigerator, such as, set refrigeration temperature for the refrigerating region. Then, the refrigerator can automatically regulate the temperature of the refrigerating region to reach the set refrigeration temperature. Alternatively, the user can log in to an application (APP) for managing the refrigerator, the APP being communicably coupled with the refrigerator. The user can set different temperatures for different regions of the refrigerator. Then, the refrigerator can regulate the temperatures accordingly based on the different temperatures set by the user.

However, the intelligent regulation of the temperature of the refrigerator still requires the user to first manually set the temperature, then regulating temperature according to the set temperature by the refrigerator. The intelligence degree is low, and the user experience is poor.

### SUMMARY

According to a first aspect of embodiments of the present disclosure, there can be provided a temperature regulating method, which is applied in a refrigerator, wherein the method can include determining a target user who intends to use the refrigerator acquiring target preference information of the target user on food, wherein the target preference information contains at least a target food type, a target dining time, and a target food state, determining target food from food currently stored in the refrigerator based on the target food type, and regulating a temperature of a region where the target food is stored, such that the target food reaches the target food state by the target dining time.

According to a second aspect of embodiments of the present disclosure, there can be provided a temperature regulating device, which can be applied in a refrigerator, wherein the device can include a processor, and a memory for storing instructions executable by the processor, wherein the processor can be configured to determine a target user who intends to use the refrigerator, acquire target preference information of the target user on food, wherein the target preference information contains at least a target food type, a target dining time and a target food state, determine target food from food currently stored in the refrigerator based on the target food type, and regulate a temperature of a region where the target food is stored, such that the target food reaches the target food state by the target dining time.

According to a third aspect of the embodiment of the present disclosure, there can be provided a non-transitory computer-readable storage medium storing instructions, executable by a processor in a device, for performing a temperature regulating method applied in a refrigerator, comprising determining a target user who intends to use the refrigerator, acquiring target preference information of the target user on food, wherein the target preference information contains at least a target food type, a target dining time and a target food state, determining target food from food currently stored in the refrigerator based on the target food type, and regulating a temperature of a region where the target food is stored, such that the target food reaches the target food state by the target dining time.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart illustrating a temperature regulating method according to an exemplary embodiment of the present disclosure;

FIG. 2 is a flow chart illustrating another temperature regulating method according to an exemplary embodiment of the present disclosure;

FIG. 3 is a block diagram illustrating a temperature regulating device according to an exemplary embodiment of the present disclosure;

FIG. 4 is a block diagram illustrating another temperature regulating device according to an exemplary embodiment of the present disclosure;

FIG. 5 is a block diagram illustrating another temperature regulating device according to an exemplary embodiment of the present disclosure;

FIG. 6 is a block diagram illustrating another temperature regulating device according to an exemplary embodiment of the present disclosure;

FIG. 7 is a block diagram illustrating another temperature regulating device according to an exemplary embodiment of the present disclosure;

FIG. 8 is a block diagram illustrating another temperature regulating device according to an exemplary embodiment of the present disclosure;

FIG. 9 is a block diagram illustrating another temperature regulating device according to an exemplary embodiment of the present disclosure;

FIG. 10 is a block diagram illustrating another temperature regulating device according to an exemplary embodiment of the present disclosure;

FIG. 11 is a block diagram illustrating another temperature regulating device according to an exemplary embodiment of the present disclosure; and

FIG. 12 is a block diagram illustrating a temperature regulating device according to an exemplary embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

The terms used herein are merely for describing a particular embodiment, rather than limiting the present disclosure. As used in the present disclosure and the appended claims, terms in singular forms such as “a”, “said” and “the” are intended to also include plural forms, unless explicitly dictated otherwise. It should also be understood that the term “and/or” used herein means any one or any possible combination of one or more associated listed items.

It should be understood that, although it may describe an element with a term first, second, or third, etc., the element is not limited by these terms. These terms are merely for distinguishing among elements of the same kind. For example, without departing from. the scope of the present disclosure, a first element can also be referred to as a second element. Similarly, a second element can also be referred to as a first element. Depending on the context, a term “if” as used herein can be interpreted as “when”, “where” or “in response to”.

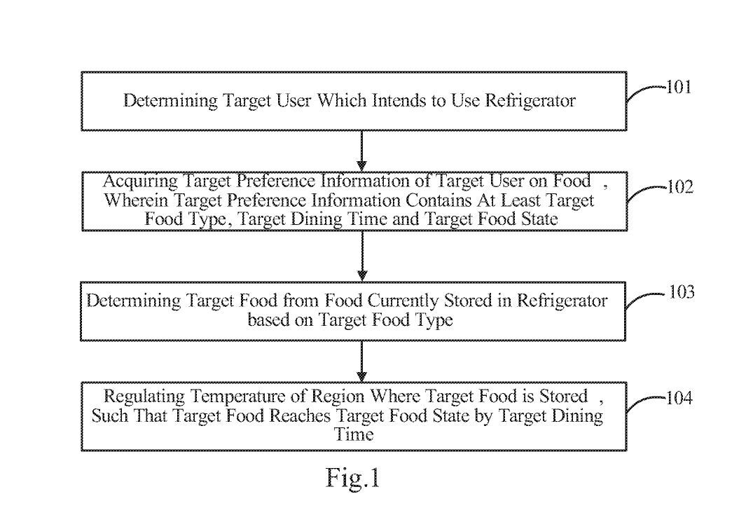

FIG. 1 is a flow chart illustrating a temperature regulating method according to an exemplary embodiment. As shown in FIG. 1, the method is applied in a refrigerator.

In step 101, a target user who intends to use the refrigerator can be determined. In the present step, the target user can be determined through one or more of the techniques. For example, a first user who has logged into an application APP for managing the refrigerator can be determined as the target user, wherein the application APP for managing the refrigerator has been previously communicably coupled with the refrigerator. When the first user logs into the application APP for managing the refrigerator, which has been previously communicably coupled with the refrigerator, the refrigerator can acquire user information about the first user to determine the first user as the target user.

Alternatively, a user who is online through a local area network to which the refrigerator is connected can be determined as the target user. The user who has logged into the local area network at home can be determined as the target user who intends to use the refrigerator. Optionally, the refrigerator can be connected to the local area network, such that the refrigerator can automatically acquire the second user who is online in the local area network and can take the acquired user as the target user.

The target user can also be determined through a Global Positioning System, Optionally, in step 101-1, location information about a current location of a terminal is acquired through a Global Positioning System, wherein the terminal has been previously bound with the refrigerator. Based on relevant technology, location information about a current location of at least one terminal can be acquired through a Global Positioning System, the at least one terminal having been previously communicably coupled with the refrigerator. It can be determined if the terminal is located within a predetermined distance from the refrigerator based on the location information.

In the present step, based on the location information, it can be determined if the terminal is located within the preset distance range. If the terminal is located within the preset distance range, it means that the user of the terminal can arrive at home within a predetermined time, such as within one hour, for example.

Optionally, or additionally, the user of the terminal can be determined as the target user. For example, the user who can arrive at home within a predetermined time is taken as the target user who intends to use the refrigerator.

Alternatively, the target user can be acquired through a camera connected to the refrigerator. In this manner, a user can be determined as currently at home through the camera connected to the refrigerator. Where, a camera disposed outside of the refrigerator, for example on top of the refrigerator, or an existing camera at home can be utilized. Thereby, a fifth user at home is taken as the target user.

Optionally, or additionally, through one or more of the cameras disposed outside of the refrigerator, the user who has used the refrigerator recently (i.e., within a predetermined amount of time) can be determined and taken as the target user.

In another embodiment, a user who intends to have a meal can be determined as the target user. In this manner, the refrigerator can access family members' schedules, chats, e-mails, and the like, to determine if someone may be likely to have a meal today, For example, a visitor can come to the house to have meal, and the user who will have the meal can be taken as the target user.

In step 102, target preference information of the target user on food can be acquired, the target preference information containing at least a target food type, a target dining time, and a target food state.

Optionally, the step 102 can include determining if the target user has used the refrigerator. In the present step, the refrigerator can automatically decide whether the target user has used the refrigerator based on previously stored user information about users who have used the refrigerator.

Historic preference information of the target user, which can be pre-stored in the refrigerator, can be acquired as the target preference information. Among the preference information of the users previously stored in the refrigerator, historic preference information corresponding to the target user can be taken as the target preference information. Optionally, the target preference information at least includes a target food type, a target dining time, and a target food state. The refrigerator can retrieve a food type such that the target food type can be the food type selected by the target user based on the food type selected when the target user previously opened the refrigerator, retrieve a time point when the target user previously opened the refrigerator to select food as the target dining time, and retrieve a state of the food selected by the user when he previously opened the refrigerator as the target food state.

For example, the target user may have once taken a yellow banana from the refrigerator at 9:00 am. Then, it can be determined that among the target preference information, the target food type is banana, the target dining time is 9:00 am, and the target food state is well matured. However, in order to further improve the user experience, the target food type can be further enlarged as fruit. Thus, once the refrigerator does not store banana, but contains other types of fruits such as an apple, it will nevertheless meet the demand of the target user.

The target preference information of the target user can be searched for through a local area network to which the refrigerator is connected, When the target user determined by the refrigerator has never used the refrigerator, the refrigerator has no record relevant to the target user. At this time, the refrigerator can search for information such as food types previously favored by the target user through the connected local area network to determine the target preference information. For example, the target user may have searched for a certain type of food through the local area network, such as a favorite recipe, for example. The refrigerator can acquire browser history, for example, through the local area network to determine the target preference information of the target user.

In step 103, target food can be determined from food currently stored in the refrigerator based on the target food type. Optionally, the target food can be determined from the currently stored food through a camera disposed inside the refrigerator. For example, it can be acquired through the camera disposed inside the refrigerator that food currently stored in the refrigerator includes banana, steak, celery, milk, and other food. If the target preference information includes a target food type that includes fruits and vegetable, a banana and celery can be determined to be the target food based on the food currently stored in the refrigerator.

In the embodiment of the present disclosure, in order to improve the intelligence degree of the refrigerator and improve the user experience, it can prompt the target user when the stored amount of target food required by the target food is not sufficient, thereby allowing an opportunity for the user to timely supplement the target food. The target preference information can also include a target food amount for a meal.

Optionally, or additionally, the method also includes determining if the currently stored amount of the target food in the refrigerator is sufficient based on the target food amount for a meal. In the present step, based on the target food amount for a meal, it can be decided whether the amount of the target food currently stored in the refrigerator is sufficient. For example, the target food wanted by the target user is steak, and the amount of the target food is 2 pieces. in such case, if currently there is 1 piece of steak stored in the refrigerator, then the refrigerator can decide that the currently stored amount of the target food is not sufficient.

Therefore, a notice message can be sent to the target user informing the target user that the currently stored amount of the target food is not sufficient. Optionally, or additionally, the refrigerator can generate a corresponding notice message prompting the target user to supplement the corresponding target food, and send the notice message to the target user via a connected local area network.

A temperature of a region where the target food is stored can be regulated such that the target food reaches the target food state by the target dining time. After the refrigerator determines the target food, the temperature of the region where the target food is located can be dynamically regulated. As a result, the target user can obtain from the refrigerator the target food in the target food state at the target dinging time point. For example, the target user usually eats a matured yellow banana at 9:00 am. The refrigerator currently only stores an under-matured green banana. In this case, the refrigerator can regulate the temperature of the refrigerating region, and continue determining whether the banana has reached a matured state by means of the camera inside the refrigerator, thereby ensuring that when the target user opens the refrigerator at 9:00 am, the green banana has reached a matured state.

Alternatively, the target user may want to obtain an unfrozen steak at 12:30 am. In this case, the refrigerator can regulate the temperature of the freezing region, raise the temperature of the freezing region before 12:30 am, and continue determining whether the steak has reached the unfrozen state by means of the camera inside the refrigerator, thereby ensuring that when the target user opens the refrigerator at 12:30 am, the steak is already unfrozen.

In the above embodiment, the refrigerator can automatically acquire target preference information about the target user who wants to use the refrigerator, and regulate temperature based on the acquired target preference information such that the target user can obtain from the refrigerator at a target clinging time point, target food which is in a target food state desired by the target user. Therefore, it can improve the intelligence degree of the temperature regulation of the refrigerator and may improve user experience.

FIG. 2 is a flow chart illustrating a temperature regulating method according to an exemplary embodiment. As shown in FIG. 2, the method can be applied in a refrigerator.

In step 201, a target user who intends to use the refrigerator can be determined. In the present step, a user who has logged into an application APP for managing the refrigerator can be determined as the target user, where the application APP for managing the refrigerator has been previously communicably coupled with the refrigerator. Optionally, or additionally, a user who is currently online through a local area network at home can be determined to be the target user. Further, location information about a location of a terminal of a user can be acquired through a Global Positioning System, and a user who will arrive at home in a short time can be determined as the target user. Also, a user who is currently at home or has previously used the refrigerator as determined by means of a camera connected to the refrigerator can be determined as the target user. A user who intends to have a meal can be determined as the target user such that the process of determining the target user is similar to the process described in the above step 101.

In step 202, it can be decided whether the target user has used the refrigerator. In the present step, the refrigerator can automatically determine whether the target user has used the refrigerator based on previously stored user information about users who have used the refrigerator. If the target user has used the refrigerator, it can proceed to step 203, otherwise it can proceed to step 204.

In step 203, historic preference information of the target user, which is pre stored in the refrigerator, can be acquired as the target preference information. Among the preference information of the users previously stored in the refrigerator, historic preference information corresponding to the target user can be taken as the target preference information. Optionally, or additionally, the target preference information includes one or more of a target food type, a target dining time, and a target food state. The refrigerator can retrieve a food type selected by the target user when the target user previously opened the refrigerator as the target food type, retrieve a time point when the target user previously opened the refrigerator to select food as the target dining time, and retrieve a state of the food selected by the user when the target user previously opened the refrigerator as the target food state.

In step 204, the target preference information of the target user can be searched for through a local area network to which the refrigerator is connected. When the target user determined by the refrigerator has never used the refrigerator, the refrigerator has no record relevant to the target user. At this time, the refrigerator can search for information such as food types previously favored by the target user through the connected local area network as the target preference information. For example, the target user may have once searched for a certain type of food through the local area network, for example. Correspondingly, the refrigerator can acquire the browser history, for example, through the local area network to determine the target preference information of the target user.

In step 205, target food can be determined from food currently stored in the refrigerator based on the acquired target food type. Optionally, the target food can be determined from the currently stored food through a camera disposed inside the refrigerator. For example, it can be acquired through the camera disposed inside the refrigerator that food currently stored in the refrigerator can include banana, steak, celery, milk, and other food. If the target preference information including a target food type, such as fruits and vegetables, the banana and the celery can be determined from the food currently stored in the refrigerator as the target food.

In step 206, it can be decided whether a currently stored amount of the target food in the refrigerator is sufficient based on the target food amount for a meal. When the currently stored amount is not sufficient, it can proceed to step 207, otherwise it can directly proceed to step 208. In the present step, it can be decided whether a currently stored amount of the target food in the refrigerator is sufficient based on the target food amount for a meal. When the refrigerator decides that the currently stored amount is not sufficient, it can proceed to step 207.

In step 207, a notice message can be sent to the target user informing the target user that the currently stored amount of the target food is not sufficient. Optionally, or additionally, the refrigerator can generate a corresponding notice message prompting the target user to supplement the corresponding target food, and send the notice message to the target user via a connected local area network.

In step 208, a temperature of a region where the target food is stored can be regulated such that the target food reaches the target food state by the target dining time. After the refrigerator determines the target food, the temperature of the region where the target food is located can be dynamically regulated. As a result, the target user can obtain from the refrigerator the target food in the target food state at the target dinging time point.

The above process can be described in further detail with an example, as further described herein. The refrigerator can determine currently on-line users through a connected local area network as including User A and User B. Also, location information of a terminal of User C can be determined through a Global Positioning System, and based on the location information, it can be decided whether the terminal is located within a predetermined distance from the refrigerator. When the terminal is located within the preset distance range, it can be determined that User C can arrive at home within a predetermined period of time. In addition, the refrigerator can access the schedule of the family members and acquires that User D will come for dinner, Finally, the refrigerator can determine that the target users can include User A, User B, User C, and User D.

The refrigerator can determine that User A, User B, and User C have used the refrigerator, and acquire historic preference information of the target users, which is pre-stored in the refrigerator, as the target preference information. For example, User A may want to obtain vegetable from the refrigerator at 6:00 pm, User B may want to obtain 2 pieces of matured fruit from the refrigerator at 7:00 pm, User C may want to obtain a bottle of cool milk from the refrigerator at 11:00 pm, and User D may never have used the refrigerator, but a chat record of User D and User A shows that User D wants to obtain 2 pieces of unfrozen steaks from the refrigerator at 6:30 pm.

Based on the above target preference information, the refrigerator can determine celery, apples, milk and steaks as the target food from food currently stored in the refrigerator. At this time, it can be further determined whether the currently stored amount of the target food in the refrigerator is sufficient based on target food amount for a meal. If the refrigerator currently stores only 1 piece of fruit, a notice message can be generated to inform the user that the amount of the fruit is not sufficient, and the refrigerator sends the notice message to User B through the local area network.

The refrigerator can regulate temperatures in different regions based on the previously determined target preference information. For example, the refrigerator raises temperature of the freezing region before 6:30 pm so User D can obtain unfrozen steaks from the freezing region to meet the target user's demand.

In the above embodiment, the refrigerator can determine the target user of the refrigerator in various manners. Further, the target preference information about the target user can be acquired from historic preference information previously stored in the refrigerator, or by searching through a local area network to which the refrigerator is connected. Then, the refrigerator can automatically regulate temperatures in its different regions to meet the preference of the target user. In addition, the refrigerator can automatically decide whether the amount of the target food wanted by the target user is sufficient. If the amount is not sufficient, a notice message can be sent to the target user, for the user to timely supplement the target food. Therefore, it can improve the intelligence degree of the refrigerator, and may improve the user experience.

Corresponding to the above method embodiments, the present disclosure also provides device embodiments.

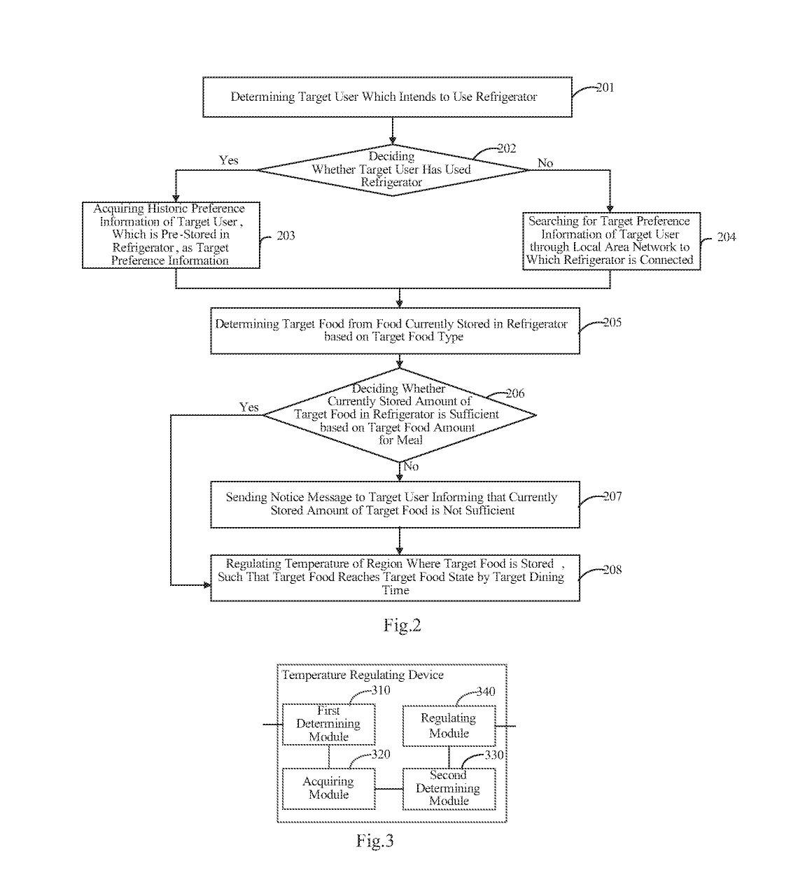

FIG. 3 is a block diagram illustrating a temperature regulating device according to an exemplary embodiment of the present disclosure. The device can be applied in a refrigerator, and can include a first determining module 310, an acquiring module 320, a regulating module 330, and a regulating module 340. The first determining module 310 can be configured to determine a target user who intends to use the refrigerator. The acquiring module 320 can be configured to acquire target preference information of the target user on food, where the target preference information contains at least a target food type, a target dining time, and a target food state. The second determining module 330 can be configured to determine target food from food currently stored in the refrigerator based on the target food type. The regulating module 340 can be configured to regulate a temperature of a region where the target food is stored, such that the target food reaches the target food state by the target dining time.

In the above embodiment, the refrigerator can automatically acquire target preference information about the target user who wants to use the refrigerator, and regulate temperature based on the acquired target preference information, such that the target user can obtain from the refrigerator at a target dinging time point target food which is in a target food state desired by the target user. Thereby, it can improve the intelligence degree of the temperature regulation of the refrigerator and may improve user experience.

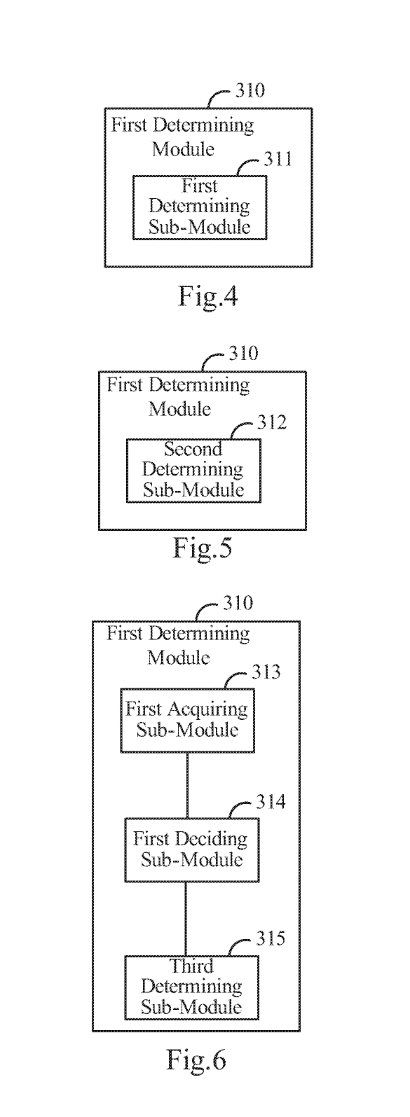

FIG. 4 is a block diagram illustrating another temperature regulating device according to an exemplary embodiment of the present disclosure. As shown in FIG. 4, the embodiment can be based on the embodiment as shown in FIG. 3. The first determining module 310 can include a first determining sub-module 311. The first determining sub-module 311 can be configured to determine a first user who has logged into an application APP for managing the refrigerator as the target user, wherein the application APP for managing the refrigerator has been previously communicably coupled with the refrigerator. The refrigerator can acquire user information about a first user who has logged into the application APP for managing the refrigerator, and then the refrigerator can determine the first user as the target user. Thereby, it can improve the intelligence of temperature regulation and may improve user experience.

FIG. 5 is a block diagram illustrating another temperature regulating device according to an exemplary embodiment of the present disclosure. As shown in FIG. 5, the embodiment can be based on the embodiment as shown in FIG. 3. The first determining module 310 can include a second determining sub-module 312. The second determining sub-module 312 can be configured to determine a second user who is online through a local area network to which the refrigerator is connected as the target user. The refrigerator can determine the second user who is currently on line through the local area network in which the refrigerator is connected as the target user. Therefore, it can improve the intelligence of temperature regulation and may improve user experience.

FIG. 6 is a block diagram illustrating another temperature regulating device according to an exemplary embodiment of the present disclosure. As shown in FIG. 6, the embodiment can be based on the embodiment as shown in FIG. 3. The first determining module 310 can include a first acquiring sub-module 313, a first deciding sub-module 314, and a third determining sub-module 315. The first acquiring sub-module 313 can be configured to acquire location information about a current location of a terminal through a Global Positioning System, where the terminal has been previously communicably coupled with the refrigerator. The first deciding sub-module 314 can be configured to decide whether the terminal is located within a predetermined distance from the refrigerator based on the location information. The third determining sub-module 315 can be configured to, when the terminal is within the predetermined distance, determine a third user of the terminal as the target user. The refrigerator can acquire a location of a terminal through the Global Positioning System and determine the third user who can arrive at home within a predetermined amount of time as the target user. Therefore, it can improve the intelligence of temperature regulation and may improve user experience.

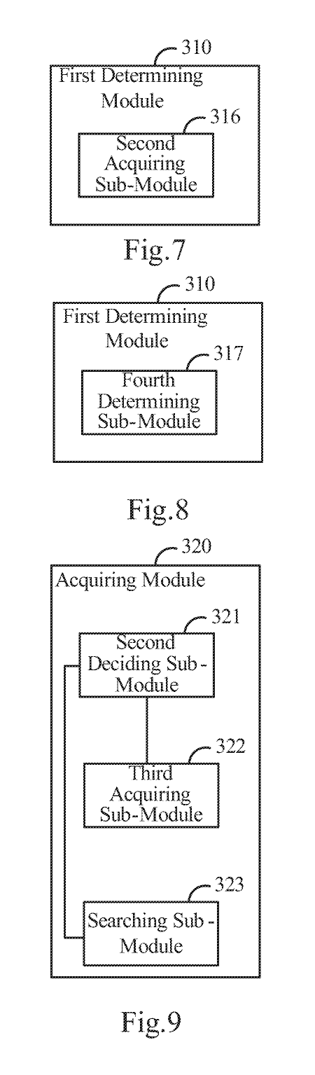

FIG. 7 is a block diagram illustrating another temperature regulating device according to an exemplary embodiment of the present disclosure. As shown in FIG. 7, the embodiment can be based on the embodiment as shown in FIG. 3. The first determining module 310 can include a second acquiring sub-module 316. The second acquiring sub-module 316 can be configured to acquire the target user through a camera connected to the refrigerator. The refrigerator can determine the fifth user who is currently at home through the camera connected to the refrigerator as the target user, or can acquire, via the camera, a fifth user who most recently opened the refrigerator as the target user. Therefore, it can improve the intelligence of temperature regulation and may improve user experience.

FIG. 8 is a block diagram illustrating another temperature regulating device according to an exemplary embodiment of the present disclosure. As shown in FIG. 8, the embodiment can be based on the embodiment as shown in FIG. 3. The first determining module 310 can include a fourth determining sub-module 317. The fourth determining sub-module 317 can be configured to determine a fourth user who intends to have a meal as the target user. The refrigerator can inquire schedules, chat records or emails of the family members through the connected local area network. The refrigerator can decide whether someone will come tor dinner, for example, whether a visitor will come to the house for dinner, and the refrigerator takes the fourth user as the target user. Therefore, it can improve the intelligence of temperature regulation and may improve user experience.

FIG. 9 is a block diagram illustrating another temperature regulating device according to an exemplary embodiment of the present disclosure. As shown in FIG. 9, the embodiment can be based on the embodiment as shown in FIG. 3. The acquiring module 320 can include a second deciding sub-module 321, a third acquiring sub-module 322, and a searching sub-module 323. The second deciding sub-module 321 can be configured to decide whether the target user has used the refrigerator. The third acquiring sub-module 322 can be configured to, when the target user has used the refrigerator, acquire historic preference information of the target user, which is pre-stored in the refrigerator, as the target preference information.

The searching sub-module 323 is configured to, when the target user has never used the refrigerator, search for the target preference information of the target user through a local area network to which the refrigerator is connected.

In the above embodiment, the refrigerator can decide whether the target user has used the refrigerator, and determine the target preference information about the target user through various manners. Thereby, it can ensure the accuracy of the target preference information and may improve user experience.

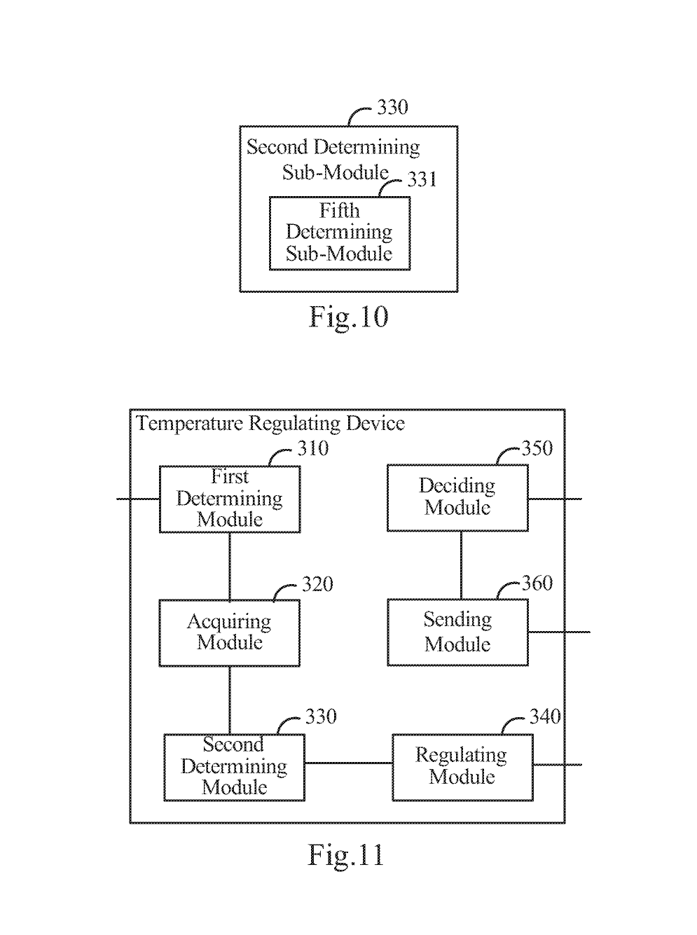

FIG. 10 is a block diagram illustrating another temperature regulating device according to an exemplary embodiment of the present disclosure. As shown in FIG. 10, the embodiment can be based on the embodiment as shown in FIG. 3. The second determining sub-module 330 can include a fifth determining sub-module 331. The fifth determining sub-module 331 can be configured to determine the target food from the currently stored food via a camera disposed inside the refrigerator. The refrigerator can determine the target food from the currently stored food through the camera provided inside the refrigerator. Therefore, it can improve the intelligence degree of the temperature regulation of the refrigerator.

FIG. 11 is a block diagram illustrating another temperature regulating device according to an exemplary embodiment of the present disclosure. As shown in FIG. 11, the embodiment can be based on the embodiment as shown in FIG. 3. The target preference information can further contains a target food amount for a meal. The device can further include a deciding module 350 and a sending module 360. The deciding module 350 can be configured to decide whether a currently stored amount of the target food in the refrigerator is sufficient based on the target food amount for a meal. The sending module 360 can be configured to, when the currently stored amount is not sufficient, send a notice message to the target user informing the target user that the currently stored amount of the target food is not sufficient. The refrigerator can automatically determine whether the amount of the target food needed by the target user is sufficient. If the amount is not sufficient, a notice message can be sent to the target user for the target user to timely supplement the target food. Therefore, it can improve the intelligence degree of temperature regulation and may improve user experience.

Implementation of the functions and operations of the modules in the above devices can be specifically referred to the implementation of the corresponding steps in the above methods, which will not be repeated herein.

For the device embodiments, since they correspond to the method embodiments, they can be referred to the related part of the description of the method embodiments. The device embodiments described above are merely illustrative. The units described as separate may be or may not be physically separate, and the components illustrated as a units may be or may not be physical units, and may be at the same location, or may be distributed to multiple units over the network A part of or all of the modules can be selected to achieve the objective of the present disclosure as desired. One skilled in the art can understand and practice the embodiments without paying creative labor.

Correspondingly, the present disclosure provides a temperature regulating device, which is applied in a refrigerator, wherein the device can include a processor, and a memory for storing instructions executable by the processor wherein the processor is configured to determine a target user who intends to use the refrigerator acquire target preference information of the target user on food, wherein the target preference information contains at least a target food type, a target dining time and a target food state, determine target food from food currently stored in the refrigerator based on the target food type, and regulate a temperature of a region where the target food is stored, such that the target food reaches the target food state by the target dining time.

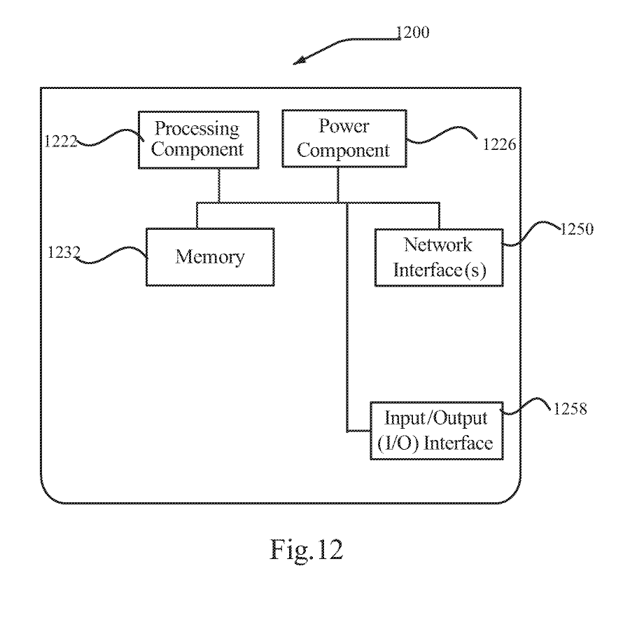

FIG. 12 is a block diagram of a device 1200 for regulating temperature according to an exemplary embodiment. For example, the device 1200 may be provided as a refrigerator. Referring to FIG. 12, the device 1200 includes a processing component 1222 that further includes one or more processors, and memory resources represented by a memory 1232 for storing instructions executable by the processing component 1222, such as application programs. The application programs stored in the memory 1232 may include one or more modules each corresponding to a set of instructions. Further, the processing component 1222 can be configured to execute the instructions to perform the above described method for regulating temperature.

The device 1200 may also include a power component 1226 configured to perform power management of the device 1200, wired or wireless network interface(s) 1250 configured to connect the device 1200 to a network, and an input/output (I/O) interface 1258. The device 1200 may operate based on an operating system stored in the memory 1232, such as Windows Server™, Mac OS X™, Unix™, Linux™, FreeBSD™, or the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A temperature regulating method, which is applied in a refrigerator, comprising:
determining, via processing circuitry, a target user who intends to use the refrigerator;
acquiring target food preference information of the target user, wherein the target food preference information contains one or more of a target food type, a target dining time, and a target food state;
determining target food from food currently stored in the refrigerator based on the target food type; and
regulating a temperature of a region where the target food is stored, such that the target food reaches the target food state by the target dining time.

2. The method of claim 1, wherein determining a target user who intends to use the refrigerator comprises;
determining a first user who has logged into an application APP for managing the refrigerator as the target user, wherein the application APP for managing the refrigerator has been previously communicably coupled with the refrigerator via a network.

3. The method of claim 1, wherein determining a target user who intends to use the refrigerator comprises;
determining a second user who is online via a local area network to which the refrigerator is connected as the target user.

4. The method of claim 1, wherein determining a target user who intends to use the refrigerator comprises:
acquiring location information about a current location of a terminal through a Global Positioning System, wherein the terminal has been previously communicably coupled with the refrigerator via the network;
deciding whether the terminal is located within a predetermined distance from the refrigerator based on the location information; and
determining a third user of the terminal as the target user when the terminal is within the predetermined distance.

5. The method of claim 1, wherein determining a target user who intends to use the refrigerator further comprises:
acquiring the target user via a camera connected to the refrigerator.

6. The method of claim 1, wherein determining a target user who intends to use the refrigerator further comprises:
determining a fourth user who intends to have a meal as the target user.

7. The method of claim 1, wherein acquiring target food preference information of the target user comprises:
determining when the target user has used the refrigerator;
acquiring historic preference information of the target user, which is pre-stored in the refrigerator, as the target food preference information when the target user has used the refrigerator; and
searching for the target food preference information of the target user through a local area network to which the refrigerator is connected when the target user has never used the refrigerator.

8. The method of claim 1, wherein determining target food from food currently stored in the refrigerator comprises:
determining the target food from the currently stored food via a camera disposed inside the refrigerator.

9. The method of claim 1, wherein the target food preference information further contains a target food amount for a meal; and
the method further comprises:
determining when a currently stored amount of the target food in the refrigerator is sufficient based on the target food amount for a meal; and
sending a notice message to the target user informing that the currently stored amount of the target food is not sufficient when the currently stored amount is not sufficient.

10. A temperature regulating device, comprising:
a processor; and
a memory for storing instructions executable by the processor;
wherein the processor is configured to perform:
determining a target user that intends to use a refrigerator;
acquiring target preference information of the target user on food, wherein the target preference information contains at least a target food type, a target dining time, and a target food state;
determining target food from food currently stored in the refrigerator based on the target food type; and
regulating a temperature of a region where the target food is stored, such that the target food reaches the target food state by the target dining time.

11. The device of claim 10, wherein determining a target user who intends to use the refrigerator comprises:
determining a first user who has logged in an application APP for managing the refrigerator as the target user, wherein the application APP for managing the refrigerator has been previously bound with the refrigerator.

12. The device of claim 10, wherein determining the target user who intends to use the refrigerator comprises:
determining a second user who is online through a local area network to which the refrigerator is connected, as the target user.

13. The device of claim 10, wherein determining the target user that intends to use the refrigerator comprises:
acquiring location information about a current location of a terminal through a Global Positioning System, wherein the terminal has been previously bound with the refrigerator;
deciding whether the terminal is located within a preset distance from the refrigerator based on the location information; and
when the terminal is within the preset distance, determining a third user of the terminal as the target user.

14. The device of claim 10, wherein determining the target user who intends to use the refrigerator comprises:
acquiring the target user through a camera connected to the refrigerator.

15. The device of claim 10, wherein determining the target user who intends to use the refrigerator comprises:
determining a fourth user who intends to have a meal as the target user.

16. The device of claim 10, wherein acquiring target preference information of the target user on food comprises:
deciding whether the target user has used the refrigerator;
when the target user has used the refrigerator, acquiring historic preference information of the target user, which is pre-stored in the refrigerator, as the target preference information; and
when the target user has never used the refrigerator, searching for the target preference information of the target user through a local area network to which the refrigerator is connected.

17. The device of claim 10, wherein determining target food from food currently stored in the refrigerator comprises:
determining the target food from the currently stored food by means of a camera disposed inside the refrigerator.

18. The device of claim 10, wherein the target preference information further contains a target food amount for a meal; and
the processor is further configured to perform:
deciding whether a currently stored amount of the target food in the refrigerator is sufficient based on the target food amount for a meal; and
when the currently stored amount is not sufficient, sending a notice message to the target user to inform the target user that the currently stored amount of the target food is not sufficient.

19. A non-transitory computer-readable storage medium having stored therein instructions that, when executed by a processor of a device, causes the device to perform a temperature regulating method applied in a refrigerator, the method comprising:
determining a target user who intends to use the refrigerator;
acquiring target preference information of the target user on food, wherein the target preference information contains at least a target food type, a target dining time, and a target food stale;
determining target food from food currently stored in the refrigerator based on the target food type; and
regulating a temperature of a region where the target food is stored, such that the target food reaches the target food state by the target dining time.
